(19) United States
(12) Patent Application Publication
(10) Pub. No.: US 2007/0084642 A1
(43) Pub. Date: Apr. 19, 2007

(54) Shoe Scale

(75) Inventor: Marc Stevenson Maxi, Trumbull, CT (US)

Correspondence Address: Mr.Marc Stevenson Maxi, 280 Beacon Hill Road, Trumbull, CT, 06611, US

(73) Assignee: Marc Stevenson Maxi, Trumbull, CT (US)

(21) Appl. No.: 11/163,304

(22) Filed: Oct. 13, 2005

(51) Int. Cl. G01G 19/52

(52) U.S. Cl. 177/132

(57) ABSTRACT

Formula for calculating weight of individual using two scales in the shoes is Total weight=
A=(Scale1)+(Scale2)
Split weight=left foot(scale1) and Right foot(scale2)
Weight variation or Change or (B)=Total weight−total split weight
Variation in percentage point (%)=T change×100/total weight or B X 100/A=%

The shoe scale is the insertion of a scale in the sole of the shoe with a digital reader in the nose or it can be mounted on the side of the shoe. Where the reader is located will be an option and the style of the shoe might also dictate that. In the sole, a series of sensors are placed strategically in the pressure points to ensure accurate reading. The data from these sensors will be fed through fiber optic data cable into an e-prom computer chip where the computations will take place. The shoe scale will be motion sensitive. FIG. illustrate.

### DETAIL DESCRIPTION OF DRAWINGS

FIG. 1: Top View of Shoe scale showing: 1. Velcro which covers the Digital Reader
2. Top view Digital Reader

FIG. 2: Frontal view of FIG. 1 showing: 1. Velcro which covers the Digital Reader
2. Front view Digital Reader

FIG. 3: Detail View of the Components of the entire shoe.
1. Digital Reader
2. Top Portion
3. Fiber Optics
4. Inner Mesh
5. Inner Sole
6. Bottom Portion
7. Velcro
   6 Pressure Sensors (#1 thru # 6)

FIG. 4: Side View of Entire Shoe pinpointing the location of the Digital Reader.

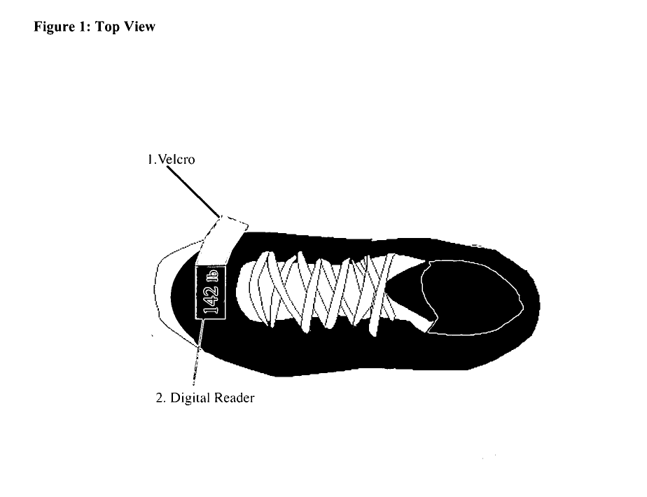

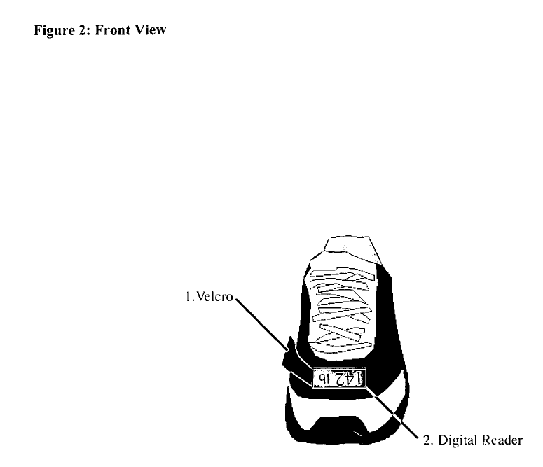

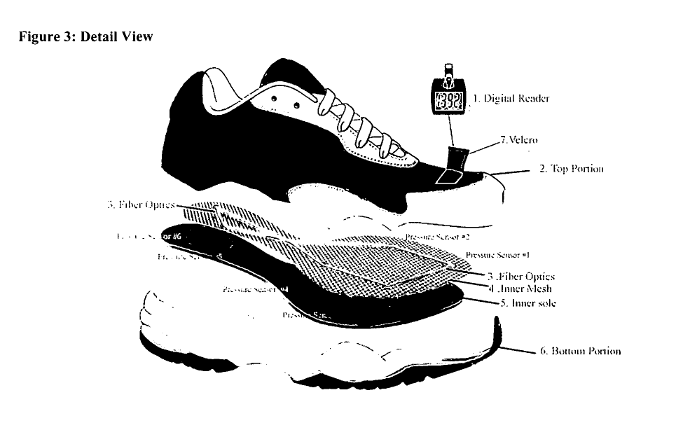

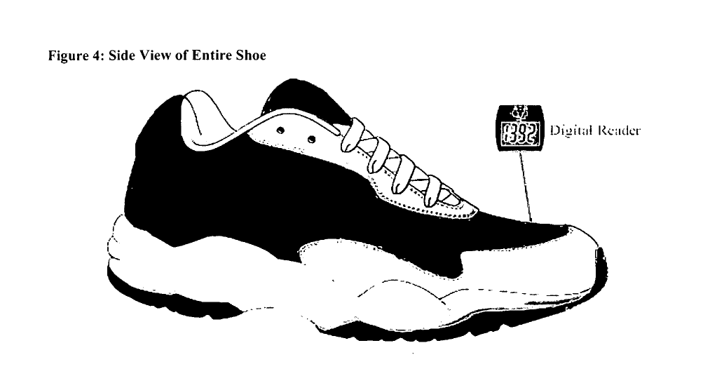

What is claimed is:

1. The purpose of the shoe scale is to provide a constant monitoring mechanism to the population to monitor their weight. As obesity becomes more and more a health issue, weight monitoring becomes a critical element in helping those affected with a constant reminder. Likewise, the shoe scale provides to the health conscious segment of the population an easier way to maintain their weight. Frankly the shoe scale will definitively serves as an incentive for people to watch their weight. Another personal observation is that generally weighing oneself is not a habit that people have and the aim of the shoe scale is to ensure that people become weight conscious. The shoe scale would become the ultimate fashion for an individual to monitor their weight lost or gain.
